(19) United States
(12) Patent Application Publication
(10) Pub. No.: US 2017/0024381 A1
(43) Pub. Date: Jan. 26, 2017

(54) WORLD LANGUAGE HOLY BIBLE

(71) Applicant: OLUWAGOKE TAIWO AJAYI, CHICAGO, IL (US)

(72) Inventor: OLUWAGOKE TAIWO AJAYI, CHICAGO, IL (US)

(21) Appl. No.: 15/212,206

(22) Filed: Jul. 16, 2016

Related U.S. Application Data
(60) Provisional application No. 62/306,107, filed on Mar. 10, 2016.

(51) Int. Cl. G06F 17/28; G09B 7/00; G06F 17/24; G10L 15/26; G10L 15/22

(52) U.S. Cl. CPC G06F 17/2836; G10L 15/26; G10L 15/22; G06F 17/24; G09B 7/00; G10L 2015/223

(57) ABSTRACT

The world language Holy Bible consists of the translations of the bible from official national languages or major world languages to the native or minor world languages across every country in the world. The world language Holy bible will be available and accessible to users in form of a bible app on android, IOS apple, windows and blackberry platform.

The world language Holy Bible have the translation of the bible in the official national languages or major languages which consist of but not limited to to English, Spanish, French, Portuguese. Mandarin. Arabic, Russian, German, Dutch. Afrikaans Hindi, Turkish, Italian. Indonesian, Bengali, Tamil, all major official African languages. major/official Asian languages, all major/official European languages, all major-official languages in the North and South America, all major/official Antarctica languages, and all major/official Australian/Oceanian languages.

The minor or native languages also consist of, but not limited to Yoruba, Ibo, Hausa, Fulani, Ijaw, Ekiti, Bantu, Fon, Zulu, all minor/native African languages, all minor native Asian languages, all minor/native European languages, all minor/native language in the North and Sooth Americas, all minor/native Antarctica languages, and all minor/native Australian/Oceanian languages.

The world language bilingual Holy Bible have the translation of the bible in the official national languages or major languages which consist of, but not limited to English, Spanish, French, Portuguese, Mandarin, Arabic, Russian, German, Dutch, Afrikaans, Hindi, Turkish, Italian, Indonesian, Bengali, Tamil, all major/official African languages, major/official Asian languages, all major/official European languages, all major/official languages in the North and South America, all major/official Antarctica languages, and all major/official Australian/Oceanian languages.

The minor or native languages also consist of, but not limited to Yoruba, Ibo, Hausa, Fulani, Ijaw, Ekiti, Bantu, Fon, Zulu, all minor/native African languages, all minor/native Asian languages, all minor/native European languages, all minor/native language in the North and South Americas, all minor/native Antarctica languages, and all minor/native Australian/Oceanian languages.

The bilingual bible will consist side by side the translation of the official national languages or major languages to the native or minor languages across the languages for users who want to read and study the bible in different languages from any the official national languages or major languages to any minor or native languages.

The app will consist of the audio version of all the languages for users who prefer to listen to the audio version.

The app will consist of a downloaded version of the bilingual bible which allows users to read the bilingual bible offline either they have access to the internet or not. There will also be a PDF version to be downloaded.

The app will consist of voice command activation mode where users can search the bilingual bible or open a part of the bilingual bible by using voice activation or voice command on every languages.

The app will have easy search options to located verses and chapter or any book in the bilingual bible on every languages.

The audio will be synched with the text as it reads along and user will have the option to pick with audio they prefer to listen to when reading the bilingual bible.

The app will consist of color mixing for effective night and day reading of the bilingual bible.

The app will consist of a note section, where users can write notes.

The app will consist of a language converter, which converts notes written down by users from one language to another language, either major language or minor language.

The app will consist of a voice to text command where users will use their voice to activate and write text for notes, highlighting, underlining a passage, or a key word.

The app will consist of a program to highlight, bold, underline words and text.

The app will consist of a kid's friendly version where graphical image will help them understand better the bilingual bible.

The app will consist of questions and answers after every chapter and book of the bilingual bible for better understanding.

The app will consist of a short quiz at the end of every chapter for users to test their knowledge in every book in the bible, both in the bilingual language of choice.

The app will consist of group chat, social media interactive forum for religious purposes only, and religious social forum or platform where users can share knowledge and content, motivate each other, send and receive contents, post ideas and share the word of God in any language of choice.

The app will consist of options to refer, invite and share with friends how to download the app.

The app will be consisting of both the online version and offline version. The online version allows users to have access to the bilingual bible when they have internet, while the offline version allows users to have access to the bilingual bible without the internet.

The app will have a platform where users can listen to motivational music and sounds in every languages in the world, both major language or native/minor language.

The app will consist of option for users to choose to read and hear the bible in any major/official national language and the translation in any minor/native language across all the languages in the world.

The app will consist of option for marketing and advertising religious and motivational products by users and nonusers of the app for a fee.

The app will be compatible with blackberry platform, android platform and apple IOS platform and windows platform, with room to upgrade more content in the app.

The app will consist of platform to market audio products, video products, books, in both soft copy and hard copy. These products will be motivational to the body, soul and spirit.

The app will consist of a text to speech command.

The app will consist of a text translator from one language to another.

The app will consist of children version of the bilingual bible with graphics, audio, video and cartoon characters for proper and better understanding for children.

The app will consist of a keyword search option.

The app will consist of platform to upload, download and watch live or pre-recorded video broadcast and audio broadcast.

The app will consist of offline version of the bilingual bible where users can download the bible, and also the online version of the bilingual bible where users can have access to the bilingual bible with the internet access.

1. The world language Holy Bible will be available and accessible to users in form of a bible app on android, IOS/apple, windows and blackberry platform.

2. The world language Holy Bible will consist side by side the translation of the official national languages or major languages to the native or minor languages across the languages for users who want to read and study the bible in different languages from any the official national languages or major languages to any minor or native languages.

3. The bible app will consist of the audio version of all the languages for users who prefer to listen to the audio version.

4. The bible app will consist of a downloaded version of the holy bible which allows users to read the holy bible offline either they have access in the internet or not. There will also be a PDF version to be downloaded.

5. The bible app will consist of voice command activation mode where users can search the holy bible or open a part of the holy bible by using voice activation or voice command on every language

6. The bible app will have easy search options to located verses and chapter or any book in the holy bible on every language.

7. The bible audio will be synched with the text as it reads along and user will have the option to pick with audio they prefer to listen to when reading the holy bible.

8. The bible app will consist of color mixing for effective night and day reading of the holy bible.

9. The bible app will consist of a note section, where users can write notes.

10. The bible app will consist of a language converter, which converts notes written down by users from one language in another language, either major language or minor language.

11. The bible app will consist of a voice to test command where users will use their voice to activate and write text for notes, highlighting, underlining a passage, or a key word.

12. The bible app will consist of a program to highlight, bold, underline words and text

13. The bible app will consist of a kid's friendly version where graphical image will help them understand better the holy bible.

14. The bible app will consist of question and answers after every chapter and book of the holy bible for better understanding.

15. The bible app will consist of a short quiz at the end of every chapter for users to test their knowledge in every book of the bible, both in the language of choice, either major or minor language.

16. The bible app will consist of group chat, social media interactive forum for religious purpose* only, and religious social forum or platform where users can share knowledge and content, motivate each other, send and receive contents, post ideas and share the word of God in any language of choice, either major or minor language.

17. The bible app will consist of options to refer, invite and share with friends how to download the app.

18. The bible app will be consisting of both the online version and offline version. The online version allows users to have access to the holy bible when they have internet, while the offline version allows users to have access to the holy bible without the internet.

19. The bible app will have a platform where users can listen to motivational music and sounds in every languages in the world, both major language or native/minor language.

20. The bible app will consist of option for users to choose to read and hear the bible in any major/official national language and the translation in any minor native language across all the languages in the world.

21. The bible app will consist of option for marketing and advertising religious and motivational products by users and non-users of the app for a fee.

22. The bible app will be compatible with blackberry platform, android platform, apple IOS platform and windows platform, with room to upgrade more content in the app.

23. The bible app will consist of platform to market audio products, video products, books, in both soft copy and hard copy. These products will be motivational to the body, soul and spirit.

24. The bible app will consist of a text to speech command.

25. The bible app will consist of a text translator from one language to another.

26. The bible app will consist of children version of the bilingual bible with graphics, audio, video and cartoon characters for proper and better understanding for children.

27. The bible app will consist of a keyword search option.

28. The bible app will consist of platform to upload, download and watch live or pre-recorded video broadcast and audio broadcast.

29. The bible app will consist of a reward point program where users get points for certain criteria they meet up with; these reward points can/may be used towards purchases on the bible app.

30. The bible app will consist of offline version of the holy bible where users can download the holy bible, and also the online version of the holy bible where users can have access to the holy bible with the internet access.
